(19) United States
(12) Patent Application Publication
(10) Pub. No.: US 2004/0226647 A1
(43) Pub. Date: Nov. 18, 2004

(54) Method for producing multi-layer electronic component

(75) Inventors: Junichi Ito, Mie (JP); Hideo Tange, Aichi (JP); Jun Otsuka, Aichi (JP); Manabu Sato, Aichi (JP); Hisahito Kashima, Aichi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 10/680,204

(22) Filed: Oct. 8, 2003

(30) Foreign Application Priority Data
May 13, 2003 (JP) 2003-134423

(51) Int. Cl. C03B 29/00

(52) U.S. Cl. 156/89.11; 156/89.12

(57) ABSTRACT

A method for producing a multi-layer ceramic capacitor 10 in which reliability of electrical contact between a via electrode 28 and an internal electrode layer 24 (24a or 24b) provided between ceramic layers 22 is enhanced. A laminated sheet 100 including ceramic layers 22 and internal electrode layers 24, the layers 22 and 24 being alternately laminated and combined together, is formed, through-holes 26 are formed in the laminated sheet 100 by means of laser irradiation, and an electrically conductive material is charged into the through-holes 26 using charging container 110, to thereby form via electrodes 28. The electrically conductive material is charged, under application of pressure, into each of the through-holes 26 via an opening of the through-hole 26.

### FIELD OF THE INVENTION

The present invention relates to a method for producing a multi-layer electronic component including a plurality of internal electrode layers which are laminated by mediation of ceramic layers.

### DESCRIPTION OF THE RELATED ART

Conventionally, this type of multi-layer electronic component has been widely employed as a multi-layer ceramic capacitor or a multi-layer ceramic inductor. In the process for producing such an electronic component, a capacitor electrode or an inductor electrode is formed on a ceramic green sheet by means of, for example, a printing technique, followed by laminating the resultant ceramic green sheet.

A multi-layer ceramic capacitor has been proposed in which electrical conduction is established between electrodes which are laminated by mediation of a ceramic green sheet. Such electrical conduction is established by charging, under application of pressure, an electrically conductive material (electrically conductive paste) into a through-hole which is formed so as to penetrate the electrodes in the lamination direction (see, for example, Japanese Patent Application Laid-Open (kokai) No. 7-193375).

### PROBLEMS TO BE SOLVED BY THE INVENTION

However, such a conventional multi-layer electronic component involves problems as described below. The aforementioned through-hole is formed by means of a hole formation technique employing a mechanical punch or a drill, or a hole formation technique utilizing thermal melting by means of laser irradiation. In the case where an electronic component requiring numerous through-holes is produced, from the viewpoint of production efficiency, the latter technique is widely pursued for forming such holes. In general, since an internal electrode layer has a melting point lower than that of ceramic sheets sandwiching the internal electrode layer, when the through-hole is formed by laser irradiation, melting of the internal electrode layer, which occurs by means of heat generated through laser irradiation, precedes melting of the ceramic sheets. As a result, a phenomenon may occur in which the surface of an end of the internal electrode layer that faces the thus-formed through-hole retracts from the wall which defines the through hole (the phenomenon may be called an “electrode receding phenomenon”). In the case where such an electrode receding phenomenon occurs, when an electrically conductive paste is charged (under application of pressure) into the through-hole, although the through-hole is filled with the conductive paste, the conductive paste may fail to reach the “receded” end surface of the internal electrode layer. This is because the internal electrode layer sandwiched between the ceramic sheets has a thickness as small as several μm. When such a phenomenon occurs, the electrically conductive paste charged into the through-hole fails to contact the internal electrode layer, and thus electrical conduction between the conductive paste and the internal electrode layer is not established. Therefore, the resultant electronic component may fail to exhibit the performance intended by its design.

### SUMMARY OF THE INVENTION

The present invention has been achieved to solve the aforementioned problems, and an object of the present invention is to provide a method for producing a multi-layer electronic component in which reliability of electrical contact between a filler in a through-hole and an internal electrode layer provided between ceramic layers is enhanced.

The above object of the present invention is achieved by providing a method for producing a multi-layer electronic component comprising ceramic layers, a plurality of internal electrode layers which are laminated by mediation of the ceramic layers, and via electrodes, each of said via electrodes penetrating the internal electrode layers and the ceramic layers in the lamination direction for connecting predetermined internal electrode layers, the method comprising:

a lamination step for alternately laminating ceramic green sheets and internal electrode layers and combining the sheets and the layers, to thereby form a laminated sheet;

a through-hole formation step for forming a through-hole in the laminated sheet by means of a laser beam such that the through-hole penetrates the ceramic green sheets and predetermined internal electrode layers; and

a charging step for charging a filler into the through-hole, to thereby form a via electrode, characterized in that, in the charging step, the filler is charged into the through-hole via an opening thereof under application of pressure such that the filler reaches, via the through-hole, an end portion of each of the predetermined internal electrode layers, the end portion facing the through-hole.

In the method for producing a multi-layer ceramic electronic component of the present invention, the laminated sheet including a plurality of the laminated ceramic green sheets, each having an internal electrode layer, is irradiated with a laser beam, to thereby form the through-hole which penetrates the ceramic green sheets and the internal electrode layers in the lamination direction. Since each of the internal electrode layers has a melting point lower than that of the ceramic green sheets, melting of the internal electrode layer, which starts from its end surface by means of heat generated through laser beam irradiation, precedes melting of the ceramic green sheets. Also, in some cases, the end surface retracts from the wall which defines the through-hole, to thereby form a recess between the through-hole wall and the end surface. In the production method of the invention, since the filler is charged into the through-hole under application of pressure, the filler reaches, via the through-hole and the above-formed recess, the end surface of the internal electrode layer. Therefore, reliable electrical conduction is established between the internal electrode layer and the via electrode formed through solidification of the filler in the through-hole.

In connection with the above-described charging step, a preferred mode thereof comprises a step for charging the filler into a charging container adapted to press, under application of pressure, the filler from the lower portion of the laminated sheet toward the upper portion thereof; a step for placing the laminated sheet between the filler-charged charging container and a pressing plate by providing the laminated sheet on the charging container such that a first outer surface of the laminated sheet faces the charging container and by providing the pressing plate on a second outer surface of the laminated sheet; and a step for charging the filler into the through-hole by applying pressure to the charging container and the pressing plate, with the laminated sheet being placed on the charging container. In this mode of the present invention, the pressing plate supports the laminated sheet so as to counter the pressure under which the filler is supplied from the charging container, whereby the filler supplied from the charging container can be charged into the through-hole of the laminated sheet.

In the above-described charging step, preferably, the pressure applied to the pressing plate and the charging container is 2 to 7.5 MPa. When the pressure under which the filler is supplied from the charging container is equal to or higher than 2 MPa, which is the lower limit, the filler can be reliably charged into the through-hole. When the pressure is equal to or lower than 7.5 MPa, which is the upper limit, even if the viscosity of the filler is high, the filler can be reliably charged into the through-hole.

In connection with the aforementioned filler, preferably, the filler is an electrically conductive paste containing an organic solvent and metallic powder having an average particle size of 2 μm or less. The metallic powder may be, for example, powder of Ag, Ag—Pt, Ag—Pd, Au, Ni, or Cu, or a mixture of such metallic powders. Herein, the average particle size of the metallic powder is determined to be 2 μm or less, for the following reason. When the average particle size of the metallic powder exceeds 2 μm, the metallic powder encounters difficulty in entering the recess between the through-hole wall and the end surface of the internal electrode layer, and thus electrical connection between the via electrode and the end surface of the internal electrode is impaired.

In connection with the aforementioned electrically conductive paste, preferably, the paste is prepared to have a viscosity of 100 to 20,000 Pa.s. The viscosity of the paste can be regulated by adjusting, for example, the amount of the metallic powder or the amount of the organic solvent. The viscosity of the paste is set to within the above range, for the following reasons. When the viscosity is lower than 100 Pa.s, upon removal of the pressure applied to the charging container, the electrically conductive paste which has been charged into the through-hole may fail to remain therein, and may return to the charging container. In contrast, when the viscosity exceeds 20,000 Pa.s, the electrically conductive paste is insufficiently charged into the aforementioned recess.

The organic solvent employed in the electrically conductive paste may be, for example, butyl carbitol or terpineol. If desired, the electrically conductive paste may contain an inorganic compound powder, such as BaTiO₃, SrTiO₃, TiO₂, Al₂O₃and/or MgO in an amount of 0-40% by volume. The inorganic compound powder prevents problems, including occurrence of cracking caused by stress generated by the difference in shrinkage upon sintering between the ceramic green sheet and the internal electrode layer.

In connection with a preferred mode of the production process of the present invention, the aspect ratio of the via electrode, which is defined by the ratio of the length of the via electrode to the diameter thereof, is 4 to 2.

The diameter of the via electrode is preferably 50 μm to 120 μm, more preferably 60 μm to 110 μm, much more preferably 70 μm to 100 μm. The distance between adjacent via electrodes is preferably 100 μm to 1,000 μm, more preferably 100 μm to 600 μm, much more preferably 150 μm to 450 μm. As used herein, the expression “the distance between adjacent via electrodes” refers to the distance between the centers of adjacent via electrodes; i.e., the pitch between the via electrodes.

### BRIEF DESCRIPTION OF THE DRAWINGS

FIG. 1 is a vertical cross-sectional view of a multi-layer ceramic capacitor 10, which is an embodiment of the present invention.

FIGS. 2(A) and 2(B) are explanatory views showing electrical connection between via electrodes 28 and internal electrode layers 24 of alternating ceramic layers 22.

FIG. 3 is a flowchart showing a process for producing the multi-layer ceramic capacitor 10.

FIGS. 4(A) and 4(B) are explanatory views of the production process shown in FIG. 3.

FIG. 5 is an explanatory view schematically showing the state after completing lamination of ceramic sheets and a laser irradiation procedure.

FIG. 6 is an explanatory view schematically showing a laminated sheet 100 in which through-holes 26 are formed.

FIG. 7 is an explanatory view showing a laser irradiation procedure.

FIG. 8 is an explanatory view showing the step of charging of an electrically conductive material using a charging container 110.

FIG. 9 is an explanatory view showing the step of charging the electrically conductive material.

The following is a description of reference numerals used in the drawings.

10 multi-layer ceramic capacitor

22 ceramic layer

22A ceramic green sheet

24 internal electrode layer

24a first internal electrode layer

24b second internal electrode layer

24c end surface

25 (25a, 25b) aperture

25A region in which apertures are vertically aligned

25B region which surrounds apertures

26 through-hole

28 via electrode

28a first via electrode

28b second via electrode

30a first terminal

30b second terminal

32 cover layer

33 exfoliation sheet

34 cover sheet

50 laser beam

100 laminated sheet

110 charging container

112 casing

114 bottom plate

116 actuator

118 pressing plate

### DETAILED DESCRIPTION OF THE PREFERRED EMBODIMENTS

The present invention will next be described with reference to a specific embodiment and the accompanying drawings. However, the present invention should not be construed as being limited thereto.

(1)-1 Overall Configuration of Multi-Layer Ceramic Capacitor 10

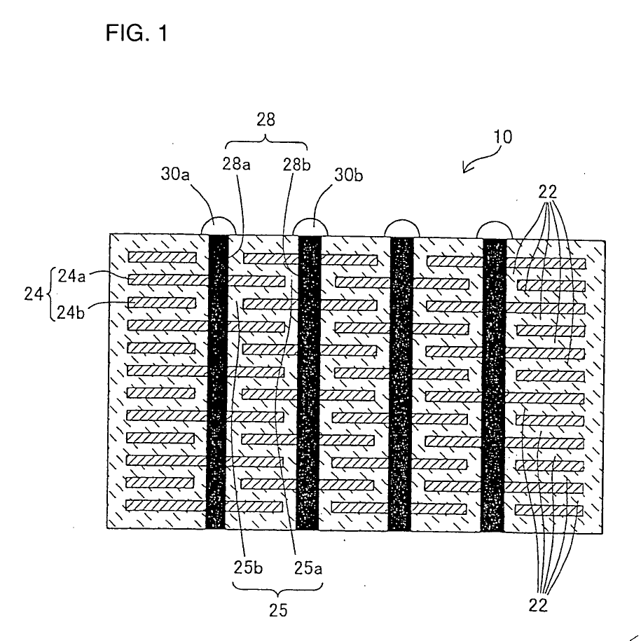

FIG. 1 is a vertical cross-sectional view of a multi-layer ceramic capacitor 10, which is an embodiment of the present invention. As described below, the multi-layer ceramic capacitor 10 is produced through lamination of ceramic green sheets. When the thus-laminated sheets are subjected to firing, the sheets are combined together by sintering. FIG. 1 shows the state after sintering of the sheets. The multi-layer ceramic capacitor 10 includes a plurality of internal electrode layers 24 which are formed of an electrically conductive material and are laminated by the mediation of ceramic layers 22. Each of the internal electrode layers 24 includes a first internal electrode layer 24a and a second internal electrode layer 24b, and the layers 24a and 24b are alternately disposed. The ceramic layer 22 provided between the internal electrode layers 24 serves as a dielectric (insulating layer). The ceramic layer 22 is formed of, for example, a ceramic material having a high dielectric constant, such as barium titanate (BaTiO₃).

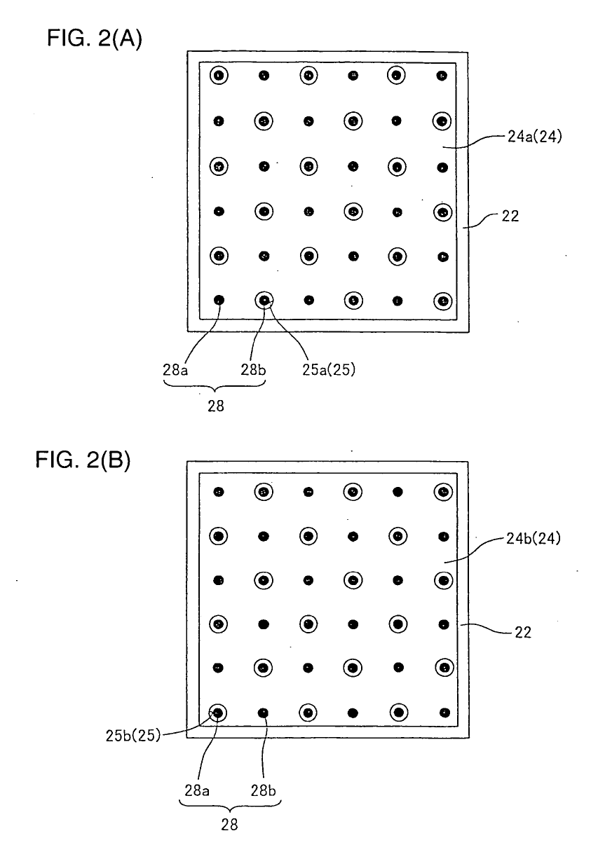

The first and second internal electrode layers 24a and 24b constituting an internal electrode layer 24 are formed alternately and are electrically connected to via electrodes 28a and 28b, respectively, through which voltage is externally supplied. Particularly, each of the via electrodes 28 includes a first via electrode 28a and a second via electrode 28b, which extend in the lamination direction. FIG. 2 is an explanatory view showing the connection between the via electrodes 28 and the internal electrode layers 24. FIG. 2(A) is a horizontal cross-sectional view of a portion of the multi-layer ceramic capacitor 10, the portion including the first internal electrode layers 24a; and FIG. 2(B) is a horizontal cross-sectional view of a portion of the capacitor 10, the portion including the second internal electrode layers 24b.

As shown in FIG. 2(A), a first internal electrode layer 24a is electrically connected to each of the first via electrodes 28a, since the electrodes 28a penetrate the layer 24a, and the first internal electrode layer 24a is electrically insulated from each of the second via electrodes 28b by means of apertures 25a surrounding the electrodes 28b. Meanwhile, as shown in FIG. 2(B), a second internal electrode layer 24b is electrically connected to each of the second via electrodes 28b, since the electrodes 28b penetrate the layer 24b, and the second internal electrode layer 24b is electrically insulated from each of the first via electrodes 28a by means of apertures 25b surrounding the electrode 28a. As shown in FIG. 1, a plurality of terminal units, each including a first terminal 30a and a second terminal 30b, are provided on at least one of the outermost surfaces of the capacitor which extend in a direction perpendicular to the direction of lamination of the ceramic layers 22 and the first and second internal electrode layers 24a and 24b.

Thus, when voltage is applied, through the first and second terminals 30a and 30b and the via electrodes 28, to each of the internal electrode layers 24, positive charges accumulate in one of the first and second internal electrode layers 24a and 24b, which face each other via the ceramic layer 22 serving as a dielectric. Also, negative charges accumulate in the other electrode layer. This phenomenon occurs in each of the opposing internal electrode layers, and the multi-layer ceramic capacitor 10 functions as a capacitor. In order to obtain a higher capacitance, the multi-layer ceramic capacitor 10 is configured such that the first internal electrode layers 24a and the second internal electrode layers 24b are alternately provided in the lamination direction so as to sandwich the ceramic layers 22, thereby forming a plurality of capacitor units. Therefore, the total capacitance of the capacitor units is obtained from the capacitor 10 as the capacitance between the first and second terminals 30a and 30b.

As in the case of a conventional multi-layer ceramic capacitor, in the multi-layer ceramic capacitor 10, the first via electrodes 28a and the second via electrodes 28b are alternately juxtaposed throughout each of the first internal electrode layers 24a and the second internal electrode layers 24b, respectively, so as to form a grid-like pattern, and the direction of current flowing through each of the first via electrodes 28a is opposite that of current flowing through each of the second via electrodes 28b. Therefore, the capacitor 10 exhibits reduced inductance.

(2) Production Process of the Multi-Layer Ceramic Capacitor 10

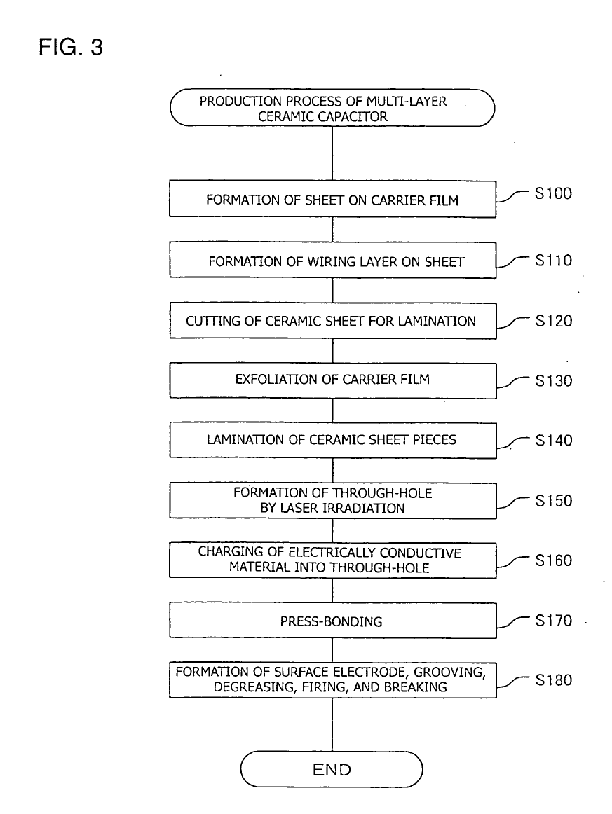

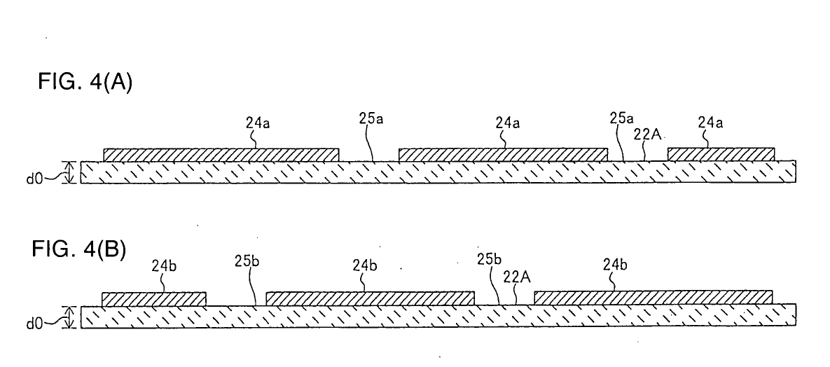

FIG. 3 is a flowchart showing the production process of the multi-layer ceramic capacitor 10, and FIG. 4 is an explanatory view of the production process shown in FIG. 3. The multi-layer ceramic capacitor 10 is produced by steps S100 to S180 shown in FIG. 3. The production process will next be described in the order of steps.

(2)-1 Formation of Sheet on Carrier Film (Step S100)

Firstly, a ceramic slurry containing barium titanate (BaTiO₃) is uniformly and thinly applied to an elongated carrier film such as a PET (polyethylene terephthalate) film, and the slurry is dried. Through this procedure, a ceramic green sheet 22A is formed on the carrier film. The ceramic green sheet 22A becomes the ceramic layer 22 after firing.

(2)-2 Formation of Electrode Layer on Sheet (Step S110)

Subsequently, an Ag—Pd electrode pattern is formed on the thus-dried ceramic green sheet 22A by means of, for example, a screen printing technique. Thus, the electrode pattern formed on the surface of the ceramic green sheet 22A serves as an internal electrode layer 24 (specifically electrode layers 24a and 24b of FIGS. 4(A) and 4(B)). Portions of the ceramic green sheet 22A on which the electrode pattern is not formed serve as the apertures 25 (25a and 25b). In the present embodiment, the thicknesses of the internal electrode layers 24 and the ceramic green sheet 22A are set to 2 to 3 μm and 5 μm, respectively.

(2)-3 Cutting of Ceramic Sheet for Lamination and Exfoliation of Carrier Film (Steps S120 and S130)

Subsequently, while the elongated carrier film having the above-formed ceramic green sheet 22A is conveyed, the ceramic green sheet 22A having the internal electrode layer 24 on its surface is cut into pieces of predetermined shape. The thus-cut pieces of the ceramic green sheet 22A are exfoliated from the carrier film by means of, for example, winding of the carrier film. As shown in FIGS. 4(A) and 4(B), the ceramic green sheet 22A is cut into two types of pieces having different layouts of the internal electrode layer 24 and the apertures 25. FIG. 4(A) corresponds to the cross-sectional view of FIG. 2(A), and FIG. 4(B) corresponds to the cross-sectional view of FIG. 2(B).

(2)-4 Lamination of Ceramic Sheet Pieces (Step S140)

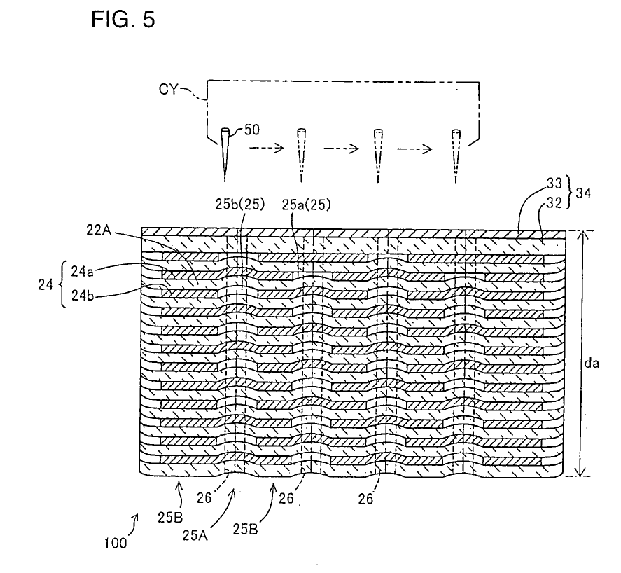

FIG. 5 is an explanatory view schematically showing the state after completion of lamination of the ceramic sheet pieces and a laser irradiation procedure in the below-described step. Subsequently, a predetermined number of the above-formed pieces of the ceramic green sheet 22A are laminated. During this lamination procedure, firstly, a cover sheet 34 is provided. As shown in FIG. 5, the cover sheet 34 includes an exfoliation sheet 33 formed of PET (polyethylene terephthalate) and a cover layer 32 formed on the sheet 33, the layer 32 being formed by thickly applying a ceramic slurry to the sheet 33 and drying the thus-applied slurry.

Subsequently, on the cover layer 32 of the above-provided cover sheet 34, the two types of ceramic green sheet pieces 22A shown in FIGS. 4(A) and 4(B) are alternately laminated as shown in FIG. 5. During the course of laminating the sheet pieces, as shown in FIG. 5, the lowermost ceramic green sheet 22A piece is laminated such that the internal electrode layer 24 of the sheet piece contacts the cover layer 32, and the subsequent ceramic green sheet piece 22A is laminated such that the internal electrode layer 24 of the sheet piece contacts the above-laminated ceramic green sheet piece 22A. By this sheet lamination procedure, a ceramic laminated sheet 100 is produced.

The thickness (da) of the entirety of the laminated sheet 100 including the cover sheet 34 determines the thickness of the multi-layer ceramic capacitor 10 (i.e., the final product). The thickness (d0) of each of the ceramic green sheet pieces 22A (see FIG. 4), the total number of the laminated sheet pieces, and the thickness of the cover layer 32, which determine the thickness (da), are adjusted in consideration of the target specification and size of the multi-layer ceramic capacitor 10. In the present embodiment, the thickness (da) of the entirety of the ceramic laminated sheet is set to 1 mm.

In the state where lamination of the sheet pieces is completed, because the sheet pieces are green, a portion of the green sheet piece that is located above each of the apertures 25 (25a and 25b) hangs downward in the aperture to some extent. At an end portion of the laminated sheet, as viewed in the cross section, each of the pieces of the ceramic green sheet 22A bends up and down.

As shown in FIG. 5, in a region in which the apertures 25 are vertically aligned (a region 25A), only every other internal electrode layer among layers 24a, 24b has apertures 25a or 25b, respectively. Meanwhile, in a region which surrounds the apertures 25 (a region 25B), the internal electrode layers 24a and 24b are vertically aligned through the entirety of the laminated green sheet pieces, such that bending of the green sheet pieces does not occur. Therefore, portions of the uppermost green sheet piece which are located within the region 25B project slightly outwardly from portions of the uppermost green sheet piece which are located within the region 25A.

(2)-5 Formation of Through-Hole by Means of Laser Irradiation (Step S150)

Subsequently, by use of a laser machining apparatus, through-holes 26 in which an electrically conductive material is to be charged are formed in the above-produced laminated sheet 100 as described below. In the present embodiment, the electrically conductive material charged into the through-holes 26 becomes the via electrodes 28 shown in FIG. 1 after completion of the final product.

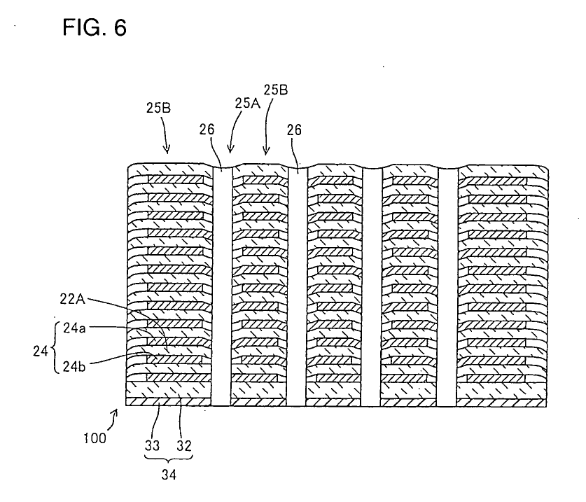

As shown in FIG. 5, in the laminated sheet 100, the apertures 25 are formed in the internal electrode layers 24a and 24b on alternating pieces of the ceramic green sheets 22A so as to be aligned in the lamination direction. A laser beam 50 is radiated from the laser machining apparatus along the axis connecting the centers of the vertically aligned apertures 25 (i.e., a dash-and-dotted line shown in FIG. 5). As a result, a portion of each of the pieces of the ceramic green sheet 22A, a portion of each of the internal electrode layers 24 (either 24a or 24b), and a portion of the cover sheet 34, the portions being located on the axis, are melted by heat generated through laser irradiation, to thereby form, around the axis, the through-hole 26 which vertically penetrates the laminate. FIG. 6 is an explanatory view schematically showing the state where the above-formed through-hole 26 extends straightly. As shown in FIG. 6, the through-hole 26 is formed such that its diameter becomes smaller than that of the apertures 25, in order to prevent electrical contact between the internal electrode layer 24 surrounding the aperture 25 and the via electrode 28 to be formed in the through-hole 26. In the present embodiment, the diameter of the through-hole 26 is set to 120 μm such that the diameter thereof becomes 100 μm after firing, and the diameter of the aperture 25 is set to 350 μm. The diameters of the through-hole and the aperture are not limited to the above values. For example, the diameter of the through-hole 26 may be 60 to 150 μm. The diameter of the through-hole may be determined in consideration of, for example, the viscosity of the below-described electrically conductive material (filler) to be charged into the through-hole 26. The diameter of the aperture 25 may be determined in consideration of, for example, the pitch between adjacently formed apertures 25.

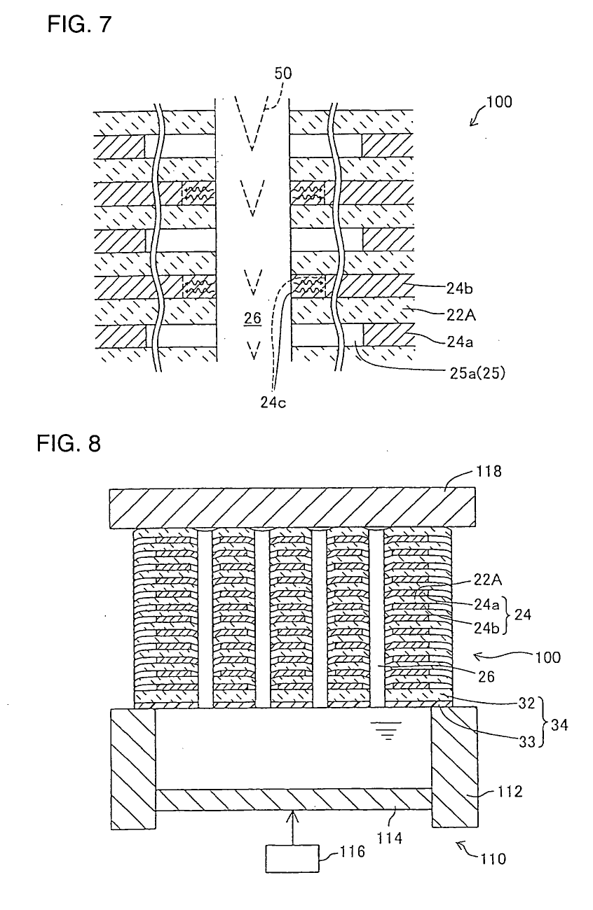

Irradiation of the laminated sheet 100 with the laser beam forms the through-hole 26 which penetrates the pieces of the ceramic green sheet 22A in the lamination direction. During the course of laser beam irradiation, as shown in FIG. 7, melting of the internal electrode layer 24, which starts from its end surface 24c by means of heat generated through laser beam irradiation, precedes melting of the ceramic green sheet 22A, since the internal electrode layer 24 has a melting point lower than that of the ceramic green sheet 22A. FIG. 7 shows the state in which the end surface 24c retracts from the wall which defines the through-hole 26, and the distance between the end surface 24c of the internal electrode layer 24 and the wall which defines the through-hole 26 becomes at most 20 μm.

The laminated sheet 100 shown in FIG. 5, having a rectangular shape as viewed from the top thereof, includes the apertures 25 which are arranged so as to form a grid-like pattern. Irradiation with the laser beam 50 is carried out at all the positions (including the positions corresponding to the four regions 25A shown in FIG. 6) of the upper surface of the rectangular-shaped laminated sheet, each of the positions corresponding to a region in which the apertures 25 are vertically aligned. Therefore, a large number of through-holes 26 are formed in the laminated sheet 100, forming a grid-like pattern.

In the present embodiment, a “cycle machining process” is employed for forming the through-holes 26 in different positions of the laminated sheet 100. In the cycle machining process, as shown in FIG. 5, a step CY in which the positions at which the through-holes are to be formed are successively irradiated with the laser beam 50 is repeatedly carried out, to thereby gradually increase the depth of the through-hole at each of the positions, and finally the through-holes are formed at all the positions.

As shown in FIG. 5, in the present embodiment, laser irradiation is carried out such that the cover sheet 34 is irradiated with the laser beam 50. This prevents adhesion, to the surface of the ceramic green sheet 22A, of products generated by melting of, for example, organic components contained in the electrode or the green sheet by means of irradiation with the laser beam 50, which is preferable.

The order of the above-described steps S110 to S150 may be varied. For example, step S140 (i.e., lamination of sheet pieces) may be carried out before step S130 (i.e., exfoliation of carrier film), or step S120 (i.e., cutting of sheet) may be carried out before step S10 (i.e., formation of electrode layer). Alternatively, steps S120, S110, S140, and S130 may be carried out in this order.

(2)-6 Charging of Electrically Conductive Material into Through-Holes (Step S160)

Subsequently, an electrically conductive material is charged into the through-holes 26 of the laminated sheet 100. FIG. 8 is an explanatory view showing the step of charging of an electrically conductive material by use of a charging container 110. The charging container 110 includes a casing 112 for accommodating an electrically conductive material, a bottom plate 114, and an actuator 116 for pressing the bottom plate 114 by use of, for example, a hydraulic cylinder, thereby supplying the electrically conductive material to the laminated sheet 100. As shown in FIG. 8, the laminated sheet 100 is mounted on the charging container 110. The position of the laminated sheet 100 is determined with respect to the charging container 110 by means of, for example, non-illustrated position-determining pins. Subsequently, a pressing plate 118 is pressed onto the upper surface of the laminated sheet 100 mounted on the charging container 110. The pressing plate 118 supports the laminated sheet 100 so as to counter the pressure under which the bottom plate 114 is pressed and the electrically conductive material is supplied from the charging container 110 into the laminate 100.

Charging of the electrically conductive material from the charging container 110 is carried out by pressing the bottom plate 114 by means of the actuator 116 while the casing 112 is filled with the electrically conductive material. By pressing the bottom plate 114, the electrically conductive material is charged into the through-holes 26 of the laminated sheet 100 under application of pressure. During the course of charging of the electrically conductive material, air contained in the through-holes 26 is discharged therefrom by means of an appropriate technique. For example, an air-permeable sheet may be provided on the lower surface of the pressing plate 118 shown in FIG. 8, or the pressing plate 118 may be formed of a porous, air-permeable plate.

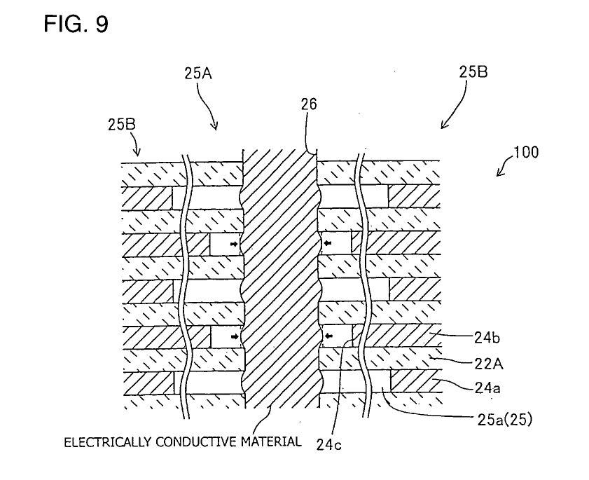

FIG. 9 is an explanatory view showing the step of charging of the electrically conductive material in the present embodiment. The electrically conductive material supplied under application of pressure is charged into each of the through-holes 26, and the conductive material reaches, via the through-hole 26, the end surfaces 24c of the internal electrode layers 24 and solidifies. The thus-solidified electrically conductive material functions as the aforementioned via electrode 28 (see FIG. 1).

In the charging step, in order to charge the electrically conductive material into each of the through-holes 26 and to cause the conductive material to reach the end surfaces 24c of the internal electrode layers 24, the operational parameters (e.g., characteristics of the electrically conductive material, the diameter of the through-hole 26, and pressure under which the material is supplied) are appropriately determined. Specifically, as the electrically conductive material, an electrically conductive paste containing an organic solvent and metallic powder having an average particle size of 2 μm or less is employed. The metallic powder may be, for example, Ag—Pd powder (the ratio of Ag to Pd may be, for example, 7:3). When the average particle size of the metallic powder exceeds 2 μm, the size of each of the particles becomes larger than the size (about 2 μm as measured in the lamination direction) of a recess extending from the end surface 24c of each of the internal electrode layers 24 toward the through-hole 26, and thus the electrically conductive material encounters difficulty in reaching the end surface 24c. An electrically conductive paste containing metallic powder having an average particle size of 3.6 μm and an electrically conductive paste containing metallic powder having an average particle size of 0.6 μm were compared for evaluation of the resulting electrical connection. As a result, the paste containing metallic powder having an average particle size of 3.6 μm was found to provide poor electrical connection.

The organic solvent may be, for example, butyl carbitol or terpineol. If desired, the electrically conductive paste may contain an inorganic compound powder. Inorganic compound powder prevents problems, including occurrence of cracking caused by stress generated by the difference in shrinkage upon sintering between the ceramic green sheets 22A and the internal electrode layers 24. The thus-prepared electrically conductive paste has a viscosity of 100 to 20,000 Pa.s, preferably 200 to 2,000 Pa.s.

The pressure under which the electrically conductive material (paste) is supplied from the charging container 110 varies in accordance with, for example, the diameter of each of the through-holes 26 or the viscosity of the electrically conductive paste. When the diameter of the through-hole 26 is 120 μm (100 μm after firing), the pressure is set so as to fall within a range of 2 to 7.5 MPa. When the pressure is equal to or higher than 2 MPa, which is the lower limit, the electrically conductive material can be reliably charged into the through-hole 26. When the pressure is equal to or lower than 7.5 MPa, which is the upper limit, even if the viscosity of the electrically conductive material is high, the material can be reliably charged into the through-hole 26.

(2)-7 Press-Bonding Step (Step S170)

Subsequently, the above-obtained charging container 110 is subjected to press-bonding by use of a high-temperature, high-pressure press. By press-bonding of the laminated sheet 100, the vertically laminated ceramic layers 22 come into close contact with one another.

(2)-8 Formation of Surface Electrode, Grooving, Degreasing, Firing, and Breaking (Step S180)

Subsequently, a surface electrode is formed on the outer surface of the laminated sheet 100 by means of, for example, screen printing. Subsequently, grooves are formed in the laminated sheet 100 in accordance with the size of the multi-layer ceramic capacitor 10 to be used in practice, and the thus-grooved laminate is subjected to degreasing, followed by firing. By firing, the multi-layer ceramic capacitor 10 shown in FIG. 1 is produced. When the above-fired laminated sheet 100 is broken along the grooves (not illustrated) formed in the grooving procedure, a multi-layer ceramic capacitor 10 of smaller size can be produced.

(3) Operation and Effects of the Embodiment

Next, the operation and effects obtained from the embodiment will be described, in which the above-described production steps are performed.

As shown in FIG. 7, in the step of forming the through-holes 26, the positions at which the through-holes are to be formed are repeatedly irradiated with the laser beam 50 as described above, and accordingly, the depth of the thus-formed holes increases. During the hole formation step, melting of the internal electrode layer 24, which starts from its end surface 24c by means of heat generated through laser beam irradiation, precedes melting of the ceramic green sheet 22A. This is because the internal electrode layer 24 formed of the Ag—Pd electrode pattern has a melting point lower than that of the ceramic green sheet 22A. Thus, the end surface 24c retracts from the wall which defines the through-hole 26, and the distance between the end surface 24c of the internal electrode layer 24 and the wall which defines the through-hole 26 becomes at most 20 μm. However, in the present embodiment, the electrically conductive material enters a recess formed between the wall which defines the through-hole 26 and the end surface 24c of the internal electrode layer 24, and thus reliable electrical conduction can be established between the via electrode 28 and the internal electrode layer 24. Particularly, in the step of charging of the electrically conductive material, the viscosity of the electrically conductive material, the average particle size of metallic powder, and the pressure under which the conductive material is charged are appropriately determined.

### EXAMPLES

Several multi-layer capacitor products 10 were produced by use of the following four electrically conductive materials of different viscosities: an electrically conductive material having a viscosity of 1,000 Pa.s (sample 1), an electrically conductive material having a viscosity of 10,000 Pa.s (sample 2), an electrically conductive material having a viscosity of 50,000 Pa.s (sample 3), and an electrically conductive material having a viscosity of 150,000 Pa.s (sample 4), which were prepared in step S160 (i.e., the step of charging of electrically conductive material).

Each of the thus-produced capacitor products was observed under a microscope for evaluation of electrical connection between the via electrode 28 and the internal electrode layer 24. As a result, in the case where sample 1 having a viscosity as low as 1,000 Pa.s was employed, sufficient electrical connection between the electrode 28 and the layer 24 was confirmed. In contrast, in the case where electrically conductive materials having a high viscosity (i.e., sample 2 having a viscosity of 10,000 Pa.s, sample 3 having a viscosity of 50,000 Pa.s, and sample 4 having a viscosity of 150,000 Pa.s) were employed, poor electrical connection between the electrode 28 and the layer 24 was confirmed. Meanwhile, even in the case where sample 4 having a viscosity of 150,000 Pa.s was employed, the resistance of the resultant capacitor product was not so high as that of the capacitor product produced by use of sample 1. However, the inductance of the capacitor product produced from sample 4 was found to be higher by 100 to 500% than that of the capacitor product produced from sample 1. These results suggest that insufficient electrical connection between the via electrode 28 and the internal electrode layer 24 greatly affects the inductance of the capacitor, rather than the resistance thereof.

The present invention is not limited to the above-described embodiments, and various modifications may be performed without departing from the scope of the present invention.

This application is based on Japanese Patent Application No. 2003-134423 filed May 13, 2003, incorporated herein by reference in its entirety.

What is claimed is:

1. A method for producing a multi-layer electronic component comprising ceramic layers, a plurality of internal electrode layers which are laminated by mediation of the ceramic layers, and via electrodes, said via electrodes penetrating the ceramic layers and predetermined internal electrode layers in the lamination direction for electrically connecting predetermined internal electrode layers, the method comprising:
alternately laminating ceramic green sheets and internal electrode layers and combining the sheets and the layers, to thereby form a laminated sheet;
forming a through-hole in the laminated sheet by means of a laser beam such that the through-hole penetrates the ceramic green sheets and predetermined internal electrode layers; and
charging a filler into the through-hole, to thereby form a via electrode, characterized in that, in the charging step, the filler is charged into the through-hole via an opening thereof under application of pressure such that the filler reaches, via the through-hole, an end portion of each of the predetermined internal electrode layers, the end portion facing the through-hole.

2. The method for producing a multi-layer electronic component as claimed in claim 1, wherein said charging comprises:
charging the filler into a charging container adapted to press, under application of pressure, the filler from the lower portion of the laminated sheet toward the upper portion thereof;
placing the laminated sheet between the filler-charged charging container and a pressing plate by providing the laminated sheet on the charging container such that a first outer surface of the laminated sheet faces the charging container and by providing the pressing plate on a second outer surface of the laminated sheet; and
charging the filler into the through-hole by applying pressure to the charging container and the pressing plate, with the laminated sheet being placed on the charging container.

3. The method for producing a multi-layer electronic component as claimed in claim 2, which comprises, in the charging step, applying a pressure of 2 to 7.5 Mpa to the pressing plate and the charging container.

4. The method for producing a multi-layer electronic component as claimed in claim 1, wherein the filler is an electrically conductive paste containing an organic solvent and metallic powder having an average particle size of 2 μm or less.

5. The method for producing a multi-layer electronic component as claimed in claim 4, wherein the electrically conductive paste has a viscosity of 100 to 20,000 Pa.s.

6. The method for producing a multi-layer electronic component as claimed in claim 1, wherein the aspect ratio of the via electrode, which is defined by the ratio of the length of the via electrode to the diameter thereof, is 4 to 25.
